(19) United States
(12) Patent Application Publication
(10) Pub. No.: US 2026/0022750 A1
(43) Pub. Date: Jan. 22, 2026

(54) HUB MOTOR WITH ELECTROMAGNETIC BRAKING DEVICE AND SCOOTER

(71) Applicants: INTRADIN (SHANGHAI) INTELLIGENT MACHINERY CO., LTD., Shanghai (CN); INTRADIN (SHANGHAI) MACHINERY CO., LTD., Shanghai (CN)

(72) Inventors: Xuetao QIAO, Shanghai (CN); Ping LI, Shanghai (CN); Yonggang ZHOU, Shanghai (CN)

(21) Appl. No.: 19/344,244

(22) Filed: Sep. 29, 2025

(30) Foreign Application Priority Data
Jul. 30, 2025 (CN) 202521613270.X

(51) Int. Cl. F16D 65/18; B60T 7/10; B60T 13/74; F16D 55/00; F16D 55/02; F16D 65/00; F16D 121/16; F16D 121/22; F16D 123/00

(52) U.S. Cl. CPC F16D 65/18; B60T 7/102; B60T 13/746; F16D 55/02; F16D 65/0056; F16D 2055/0008; F16D 2121/16; F16D 2121/22; F16D 2123/00

(57) ABSTRACT

A hub motor with an electromagnetic braking device, including a brake disc, a brake pad, a first fixing plate, a second fixing plate, a spring and a manual braking device. The brake disc is directly connected to a motor rotor. The brake pad is arranged in an inner hole of the brake disc with clearance fit. The first fixing plate is fixedly connected to a solenoid valve through a fixed column. The second fixing plate is sleevedly provided on the fixed column and movable along an axial direction of the fixed column. The spring is arranged in a spring mounting groove of the solenoid valve. The manual braking device is configured to drive the second fixing plate to move for braking and brake release. The brake pad is located between the first fixing plate and the second fixing plate. A scooter including the hub motor is also provided.

### CROSS-REFERENCE TO RELATED APPLICATIONS

This application claims the benefit of priority from Chinese Patent Application No. 202521613270.X, filed on Jul. 30, 2025. The content of the aforementioned application, including any intervening amendments made thereto, is incorporated herein by reference in its entirety.

### TECHNICAL FIELD

This application relates to motors, and more particularly to a hub motor with an electromagnetic braking device and a scooter.

### BACKGROUND

In the field of electric motors, particularly in in-wheel motors, braking devices are crucial components that ensure safe and stable operation. In the prior art, Chinese Patent No. 209913656U and Chinese Patent No. 218071220U adopt a braking scheme where three waist-shaped holes are provided on the brake disc, with three small brake pads placed inside the holes. A fixing plate 1 is arranged on the left side of the brake pads. A movable fixing plate 2 is located at the right side of the brake pads, and is adjacent to an electromagnetic valve. When the fixing plate 2 is pushed leftward by the spring of the electromagnetic valve, the brake pads are driven to impact the fixing plate 1, so that the brake disc is braked, and the brake disc further brings the rotor to a stop.

However, the prior art has certain limitations. The braking area is relatively small, and it is difficult to maintain consistent heights among the multiple brake pads. These issues lead to deteriorated braking performance, making it difficult to meet application requirements in scenarios that demand high braking precision and response speed.

### SUMMARY

An object of the disclosure is to provide a hub motor with an electromagnetic braking device and a scooter, so as to address the problem of low braking stability in the prior art.

In order to achieve the above object, the following technical solutions are adopted.

In a first aspect, this application provides a hub motor with an electromagnetic braking device, comprising:
a brake disc;
a brake pad;
a first fixing plate;
a second fixing plate;
a spring; and
a manual braking device;
wherein the brake disc is directly connected to a motor rotor, and is provided with an inner hole; and the inner hole is a non-circular hole;
the brake pad is arranged in the non-circular hole, and is in clearance fit with the brake disc;
the first fixing plate is fixedly connected to a solenoid valve through a fixed column;
the second fixing plate is sleevedly provided on the fixed column, and is movable along an axial direction of the fixed column;
the spring is arranged in a spring mounting groove of the solenoid valve, and is configured to push the second fixing plate to move towards the first fixing plate;
the manual braking device is connected to the second fixing plate, and is configured to drive the second fixing plate to move to realize switching between a braking state and an unlocked state;
the brake pad is located between the first fixing plate and the second fixing plate; and in the unlocked state, a gap between a side of the brake pad opposite to the first fixing plate and the first fixing plate and a gap between a side of the brake pad opposite to the second fixing plate and the second fixing plate are each 0.05-0.5 mm; and
the spring is arranged between the solenoid valve and the second fixing plate; when the solenoid valve is de-energized, the spring pushes the second fixing plate to move toward the first fixing plate, which in turn pushes the brake pad to contact with the first fixing plate to achieve braking; and when the solenoid valve is energized, the solenoid valve generates magnetic force to overcome the elastic force of the spring, thereby driving the second fixing plate to move away from the first fixing plate, thus separating the brake pad from the first fixing plate to achieve brake release.

In some embodiments, the manual braking device comprises a manual trigger, a steel ball and a screw; the manual trigger is provided with a trigger hole; the steel ball is arranged at the trigger hole; and the screw is connected to the second fixing plate.

In some embodiments, the unlocked state is achieved by rotating the manual trigger, in which case the trigger hole slides out of the steel ball, so that the manual trigger is pushed by the steel ball to move by 0.3-1 mm, the second fixing plate is pulled by the manual trigger through the screw to be separated from the brake pad, and the brake pad is simultaneously separated from the first fixing plate, so as to realize brake release of the motor rotor; and
the braking state is achieved by pulling the manual trigger in an opposite direction, in which case the second fixing plate is driven by the manual trigger to move towards the brake pad, so that the brake pad moves to contact with the first fixing plate until the brake pad is clamped between the first fixing plate and the second fixing plate, so as to realize braking of the motor rotor.

In some embodiments, the brake disc is in a cylindrical shape, and comprises a peripheral wall and a bottom surface connected to an inner surface of the peripheral wall; the non-circular hole is formed by partially hollowing out the bottom surface; and the non-circular hole extends from a center of the bottom surface to the peripheral wall.

In some embodiments, the non-circular hole is in a hexagonal shape, an octagonal hole or a rectangular hole; the brake pad is in shaped fit with the non-circular hole; and an axis of the non-circular hole is coincident with an axis of the brake disc, thereby ensuring uniform braking force and improving braking accuracy and stability.

In some embodiments, the fixed column is configured as at least two fixed columns that are distributed evenly spaced apart along a circumferential direction of the brake disc.

In some embodiments, the manual trigger is provided with a grip portion for easy operation; and a surface of the grip portion is provided with an anti-slip pattern.

In some embodiments, the spring is a compression spring, and is made of spring steel.

In some embodiments, both the first fixing plate and the second fixing plate are made of a wear-resistant material to extend service life.

In a second aspect, this application provides a scooter, comprising the above hub motor.

Compared to the prior art, the present disclosure has the following beneficial effects.

Regarding the hub motor of the present disclosure, the inner hole of the brake disc is designed as a non-circular hole, the brake pad is in clearance fit with the non-circular hole, and gap between a side of the brake pad opposite to the first fixing plate and the first fixing plate and a gap between a side of the brake pad opposite to the second fixing plate and the second fixing plate are each 0.05-0.5 mm. This structure can increase the size of the brake pad and simultaneously expand the braking area and the force arm, thereby increasing the braking torque. Meanwhile, two braking methods are provided, i.e., electromagnetic braking and manual braking, which improve flexibility and reliability of braking. In special cases such as solenoid valve failure or power outage, braking or brake release can be realized through the manual trigger, ensuring safe operation of the motor.

### BRIEF DESCRIPTION OF THE DRAWINGS

The present disclosure will be further described below in conjunction with the accompanying drawings and embodiments.

FIG. 1 is a perspective view of a hub motor with an electromagnetic braking device in accordance with an embodiment of the present disclosure;

FIG. 2 is a cross-sectional view of the hub motor in accordance with an embodiment of the present disclosure;

FIG. 3 is a schematic diagram of a brake disc, a brake pad and a solenoid valve in accordance with an embodiment of the present disclosure;

FIG. 4 is a schematic diagram of the brake disc in accordance with an embodiment of the present disclosure; and

FIG. 5 is a schematic diagram of a scooter including the hub motor in accordance with an embodiment of the present disclosure.

In the drawings, 1. brake disc; 2. motor rotor; 3. non-circular hole; 4. brake pad; 5. first fixing plate; 6. second fixing plate; 7. fixed column; 8. solenoid valve; 9. spring; 10. spring mounting groove; 11. manual braking device; 12. manual trigger; 13. steel ball; 14. screw; 15. trigger hole; 16. grip portion; 17. peripheral wall; 18. bottom surface; 100. scooter; and 101. hub motor.

### DETAILED DESCRIPTION OF EMBODIMENTS

The embodiments of the present disclosure are described in detail below, and are shown schematically in the accompanying drawings, where the same or similar reference numerals throughout represent the same or similar elements or elements with the same or similar functions. The embodiments described below with reference to the drawings are merely illustrative for explaining the present disclosure, and are not intended to limit the scope of the present disclosure.

In the description of the embodiments, it should be understood that orientation or positional relationships related to orientation descriptions, such as “up”, “down”, “horizontal”, “top” and “inside”, are based on orientation or position relationships shown in the drawings, which are merely intended to facilitate the description of the embodiments and simplify the description, and are not intended to indicate or imply that a device or element referred to must have a specific orientation, be constructed and operated in a specific orientation. Therefore, these orientation or positional relationships cannot be construed as limiting the present disclosure.

In the description of the present disclosure, unless otherwise clearly specified and defined, terms such as “connect” should be understood in a broad sense. For example, “connect” can be a fixed connection, a detachable connection, or an integrated connection; or can be a mechanical connection or an electrical connection; or can be a direct connection or an indirect connection through an intermediate medium. For those of ordinary skill in the art, the specific meanings of the above terms in the present disclosure can be understood according to specific circumstances.

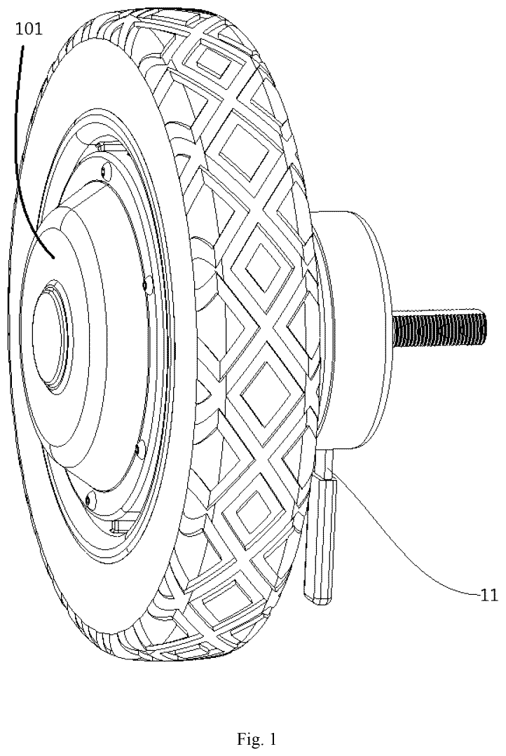

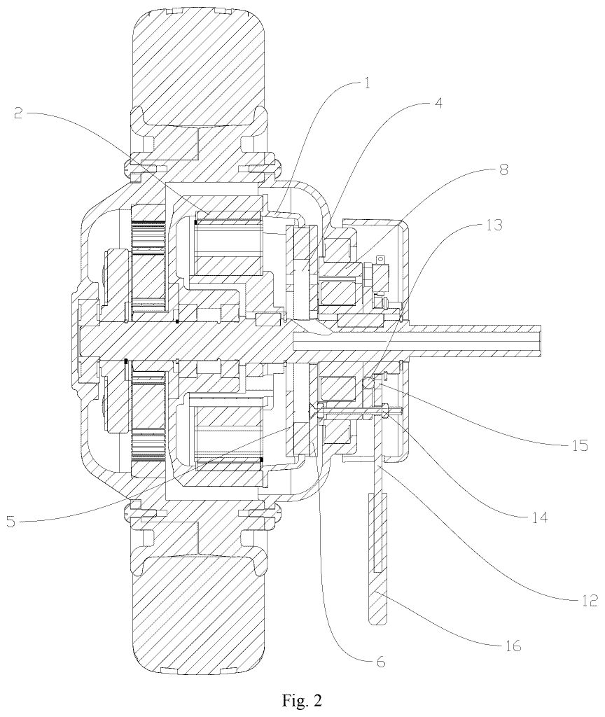

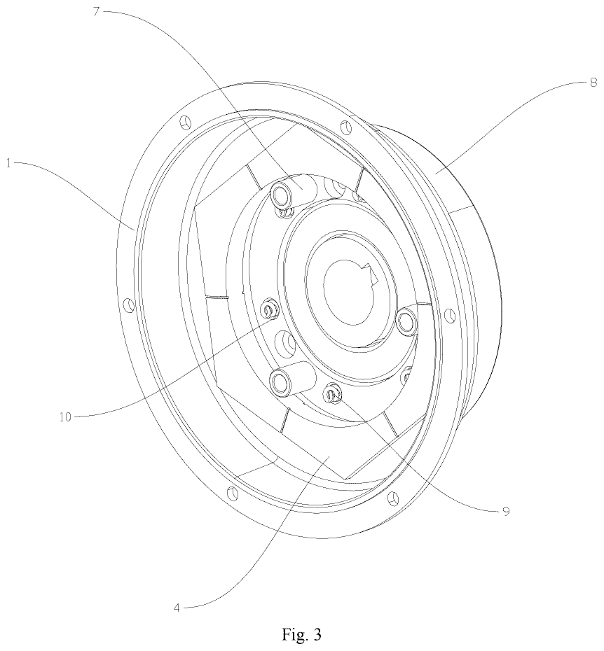

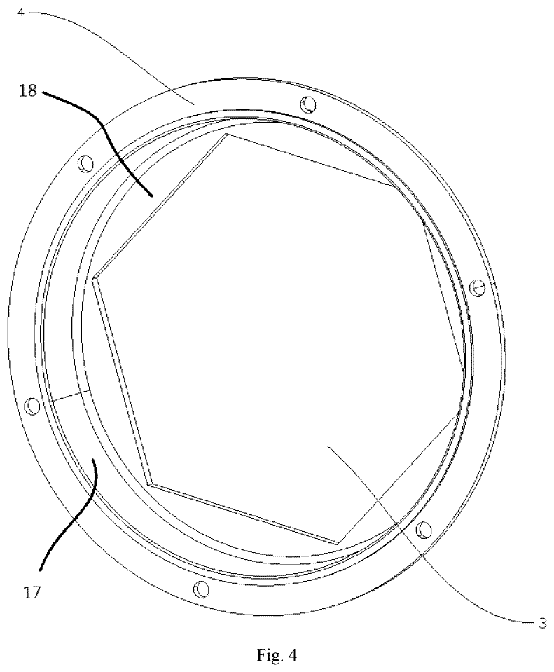

As shown in FIGS. 1-4, a hub motor 101 with an electromagnetic braking device is provided, which includes a brake disc 1, a brake pad 4, a first fixing plate 5, a second fixing plate 6, a spring 9 and a manual braking device 11.

The brake disc 1 is directly connected to a motor rotor 2, and is provided with an inner hole. The inner hole is a non-circular hole 3.

The brake pad 4 is arranged in the non-circular hole 3, and is in clearance fit with the brake disc 1.

The first fixing plate 5 is fixedly connected to a solenoid valve 8 through a fixed column 7.

The second fixing plate 6 is sleevedly provided on the fixed column 7, and is movable along an axial direction of the fixed column 7.

The spring 9 is arranged in a spring mounting groove 10 of the solenoid valve 8, and is configured to push the second fixing plate 6 to move towards the first fixing plate 5.

The manual braking device 11 is connected to the second fixing plate 6, and is configured to drive the second fixing plate 6 to move to realize switching between a braking state and an unlocked state.

The brake pad 4 is located between the first fixing plate 5 and the second fixing plate 6. In the unlocked state, a gap between a side of the brake pad 4 opposite to the first fixing plate 5 and the first fixing plate 5 and a gap between a side of the brake pad 4 opposite to the second fixing plate 6 and the second fixing plate 6 are each 0.05-0.5 mm. When the solenoid valve 8 is de-energized, the spring 9 pushes the second fixing plate 6 to move toward the first fixing plate 5, which in turn pushes the brake pad 4 to contact with the first fixing plate 5 to achieve braking. When the solenoid valve 8 is energized, the solenoid valve 8 generates magnetic force to overcome the elastic force of the spring 9, thereby driving the second fixing plate 6 to move away from the first fixing plate 5, thus separating the brake pad 4 from the first fixing plate 5 to achieve brake release.

The manual braking device 11 includes a manual trigger 12, a steel ball 13 and a screw 14. The manual trigger 12 is provided with a trigger hole 15. The steel ball 13 is arranged at the trigger hole 15. The screw 14 is connected to the second fixing plate 6. When the manual trigger 12 is rotated, the trigger hole 15 slides out of the steel ball 13, the manual trigger 12 is pushed by the steel ball 13 to move by 0.3-1 mm, the second fixing plate 6 is pulled by the manual trigger 12 through the screw 14 to be separated from the brake pad 4, and the brake pad 4 is simultaneously separated from the first fixing plate 5, so as to realize brake release of the motor rotor 2. When the manual trigger 12 is pulled in an opposite direction, the second fixing plate 6 is driven by the manual trigger 12 to move towards the brake pad 4, so that the brake pad 4 moves to contact with the first fixing plate 5 until the brake pad 4 is clamped between the first fixing plate 5 and the second fixing plate 6, so as to realize braking of the motor rotor 2.

The brake disc 1 is generally in a cylindrical shape, and includes a peripheral wall 17 and a bottom surface 18 connected to an inner surface of the peripheral wall 17. The non-circular hole 3 is formed by partially hollowing out the bottom surface 18. The non-circular hole 3 extends from a center of the bottom surface 18 to the peripheral wall 17. An axis of the non-circular hole 3 is coincident with an axis of the brake disc 1, which ensures uniform braking force and improves braking precision and stability. The non-circular hole 3 is in a hexagonal shape, and the brake pad 4 is in shaped fit with the non-circular hole 3. The number of the fixed column 7 is three, and the three fixed columns 7 are distributed evenly spaced apart along a circumferential direction of the brake disc 1. The manual trigger 12 is provided with a grip portion 16 for easy operation, and a surface of the grip portion 16 is provided with an anti-slip pattern. The spring 9 is a compression spring, and is made of spring steel. Both the first fixing plate 5 and the second fixing plate 6 are made of a wear-resistant material to extend service life. When in use, in a case where the solenoid valve 8 is de-energized, the elastic force of the spring 9 pushes the second fixing plate 6 to move toward the first fixing plate 5, which in turn pushes the brake pad 4 to move toward the first fixing plate 5, causing the brake pad 4 to contact with the first fixing plate 5. Due to the clearance fit between the brake pad 4 and the non-circular hole 3, the brake pad 4 exerts a braking effect on the brake disc 1 at this time. Since the brake disc 1 is directly connected to the motor rotor 2, braking of the motor rotor 2 is achieved. When the solenoid valve 8 is energized, the magnetic force generated by the solenoid valve 8 overcomes the elastic force of the spring 9, so that the second fixing plate 6 moves away from the first fixing plate 5, and the brake pad 4 is separated from the first fixing plate 5 to achieve the brake release.

When manual operation is required, the manual trigger 12 is pulled, so that the trigger hole 15 slides out of the steel ball 13, and the manual trigger 12 is pushed out by the steel ball 13 for a distance of 0.3-1 mm. The second fixing plate 6 is driven by the screw 14 to move away from the first fixing plate 5, separating the brake pad 4 from the first fixing plate 5, thereby achieving brake release. The manual trigger 12 is pulled in the opposite direction to drive the second fixing plate 6 to move toward the first fixing plate 5, thereby pushing the brake pad 4 into contact with the first fixing plate 5 to achieve braking.

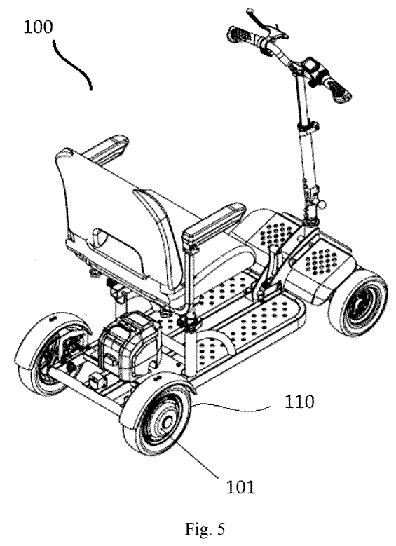

As shown in FIG. 5, a scooter 100 is provided, including the hub motor 101 with the electromagnetic braking device. In this embodiment, the hub motor 101 is installed only on a right rear wheel. In other embodiments, the hub motor 101 can be installed on a left rear wheel, or each rear wheel can be equipped with such a hub motor. In addition, the hub motor of the present disclosure can also be used in wheelchairs and other mobile devices. The application scenarios, objects, installation quantity and positions of the hub motor of the present disclosure are not limited.

In the specification, schematic representations of the above terms do not necessarily refer to the same embodiment or example. The specific features, structures, materials or characteristics described herein can be combined with each other in any one or more embodiments or examples in a suitable manner.

It should be understood that the embodiments described above are merely illustrative of the present application, and are not intended to limit the scope of the present application. Changes, modifications, replacements and variations made by those of ordinary skill in the art without departing from the principles and purposes of the present disclosure shall fall within the scope of the disclosure defined by the appended claims.

What is claimed is:

1. A hub motor with an electromagnetic braking device, comprising:
a brake disc;
a brake pad;
a first fixing plate;
a second fixing plate;
a spring; and
a manual braking device;
wherein the brake disc is directly connected to a motor rotor, and is provided with an inner hole; and the inner hole is a non-circular hole;
the brake pad is arranged in the non-circular hole, and is in clearance fit with the brake disc;
the first fixing plate is fixedly connected to a solenoid valve through a fixed column;
the second fixing plate is sleevedly provided on the fixed column, and is movable along an axial direction of the fixed column;
the spring is arranged in a spring mounting groove of the solenoid valve, and is configured to push the second fixing plate to move towards the first fixing plate;
the manual braking device is connected to the second fixing plate, and is configured to drive the second fixing plate to move to realize switching between a braking state and an unlocked state; and
the brake pad is located between the first fixing plate and the second fixing plate;
and in the unlocked state, a gap between a side of the brake pad opposite to the first fixing plate and the first fixing plate and a gap between a side of the brake pad opposite to the second fixing plate and the second fixing plate are each 0.05-0.5 mm.

2. The hub motor of claim 1, wherein the manual braking device comprises a manual trigger, a steel ball and a screw; the manual trigger is provided with a trigger hole; the steel ball is arranged at the trigger hole; and the screw is connected to the second fixing plate.

3. The hub motor of claim 2, wherein the unlocked state is achieved by rotating the manual trigger, in which case the trigger hole slides out of the steel ball, so that the manual trigger is pushed by the steel ball to move by 0.3-1 mm, the second fixing plate is pulled by the manual trigger through the screw to be separated from the brake pad, and the brake pad is simultaneously separated from the first fixing plate, so as to realize brake release of the motor rotor; and
the braking state is achieved by pulling the manual trigger in an opposite direction, in which case the second fixing plate is driven by the manual trigger to move towards the brake pad, so that the brake pad moves to contact with the first fixing plate until the brake pad is clamped between the first fixing plate and the second fixing plate, so as to realize braking of the motor rotor.

4. The hub motor of claim 1, wherein the fixed column is configured as at least two fixed columns that are distributed evenly spaced apart along a circumferential direction of the brake disc.

5. The hub motor of claim 1, wherein the manual trigger is provided with a grip portion, and a surface of the grip portion is provided with an anti-slip pattern.

6. The hub motor of claim 1, wherein the spring is a compression spring, and is made of spring steel.

7. The hub motor of claim 1, wherein both the first fixing plate and the second fixing plate are made of a wear-resistant material.

8. The hub motor of claim 1, wherein the brake disc is in a cylindrical shape, and comprises a peripheral wall and a bottom surface connected to an inner surface of the peripheral wall; the non-circular hole is formed by partially hollowing out the bottom surface; and the non-circular hole extends from a center of the bottom surface to the peripheral wall.

9. The hub motor of claim 8, wherein the non-circular hole is in a hexagonal shape, and an axis of the non-circular hole is coincident with an axis of the brake disc.

10. A scooter, comprising:
the hub motor of claim 1.
